(19) United States
(12) Patent Application Publication
(10) Pub. No.: US 2003/0233819 A1
(43) Pub. Date: Dec. 25, 2003

(54) Fruit pick

(76) Inventor: Albert Gerald Hamel, Bradenton, FL (US)

Correspondence Address: Albert G. Hamel, 305 52nd Avenue Drive E., Bradenton, FL, 34203, US

(21) Appl. No.: 10/282,264

(22) Filed: Jun. 19, 2002

(51) Int. Cl. A01D 46/22

(52) U.S. Cl. 56/329

(57) ABSTRACT

When searching for a tool to pick fruit from my back yard grapefruit tree I was disappointed to find that the only ones available either pulled the fruit from the tree removing the stem from the fruit in the process, or cut the stem and let the fruit fall on the ground. My fruit picker is designed to both cut the stem from the branch leaving it attached to the fruit and catch the fruit in a basket. It is also designed with a two piece handle and rope assembly making it easy to use and light weight.

### CROSS REFERENCE TO RELATED APPLICATIONS

Not Applicable

### STATEMENT REGARDING FEDERALLY SPONSORED RESEARCH OF DEVELOPMENT

Not Applicable

### REFERENCE TO MICROFICHE APPENDIX

Not Applicable

### BACKGROUND OF INVENTION

The FRUIT PICK is a manually operated fruit picker with a right angle cutting head to be used to pick stemmed fruit. This fruit picker doesn't pull the stems from the fruit as other forms of backyard pickers do. It, also, has a catch basket which some other types of fruit pickers do not.

### BRIEF SUMMARY OF THE INVENTION

The FRUIT PICK is designed to manually pick stemmed fruit such as grapefruit, oranges, apples, pears, peaches, plums, etc., without pulling the stem from the fruit. Pulling the stem from the fruit opens the skin allowing bacteria and air to enter the fruit, this causes the fruit to have a shorter shelf life. The FRUIT PICK, also, has a catch basket with side guides which prevents the fruit from falling to the ground, after detachment from the tree, and being damaged. It has both a stationary cutting blade and a mobile cutting blade which is controlled by the pull rope. The combination of these two blades cuts the stem from the tree dropping the undamaged fruit into the attached catch basket. The FRUIT PICK comes with an attached three foot handle with rubber grip and pull rope to reach lower branches; and a three foot extension handle and pull rope assembly for reaching the higher fruit.

### BRIEF DESCRIPTION OF THE SEVERAL VIEWS OF THE DRAWING

FIG. 1. Plan and side views of piece #1, Mobile Cutter Bearing. Pieces #2 & #2a, the Right & Left Cutter Stops. Plan view of piece #3, the Mobile Cutter Guide.

FIG. 2. Cross section pieces #2, #2a Right & Left Cutter Stops & #4 Main Cutter. Cross section pieces #3 Mobile Cutter Guide to piece #4.

FIG. 3. Plan view of piece #4 Main Cutter, showing placement and welds of piece #1, #2 & #2a.

FIG. 4. Bottom view of Piece #4 Main Cutter showing placement and weld of piece #3 to piece #4. Also, showing positioning of pieces #1, #2, & #2a.

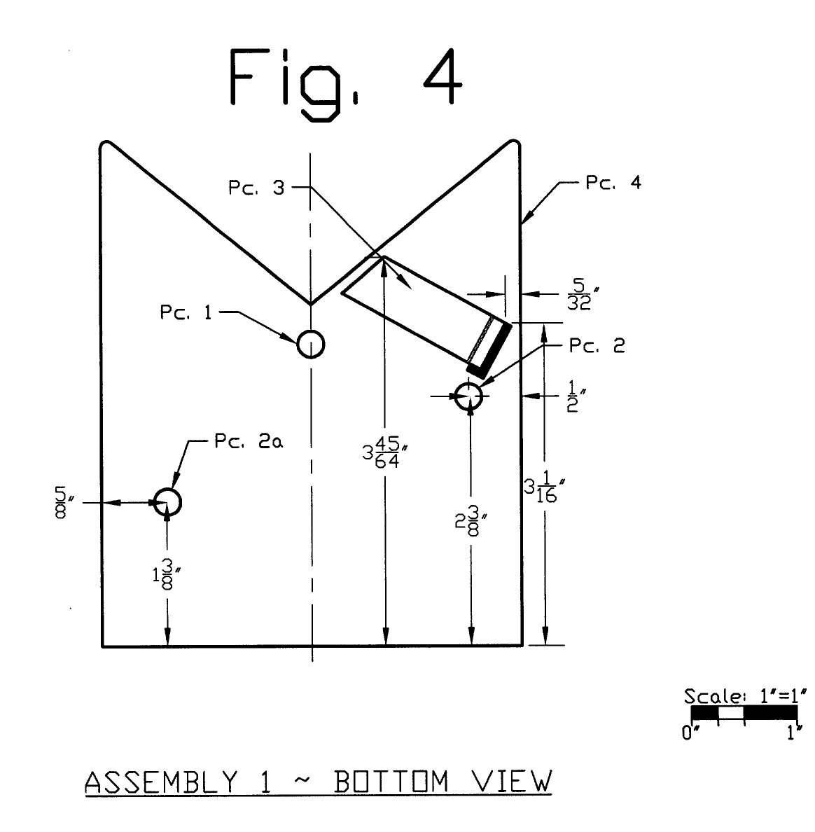

FIG. 5. Top and bottom views of piece #14 Mobile Cutter.

FIG. 6. Top and bottom views of piece #14a Mobile Cutter Offset; piece #14b Mobile Cutter Axel; and piece #14c Universal Drive Axel.

FIG. 7. Cross section of Assembly 2 consisting of pieces #14, #14a, #14b, & #14c.

FIG. 8. Plan and Side view of piece #15 Universal Connector. Plan and side views of pieces #16 & #17 Universal Bearings.

FIG. 9. Pieces #15 Universal Connector, and #15a Universal Axel. Cross section of Assembly 3 consisting of pieces #15, #15a, #15b, #15c, #15d, #16 & #17.

FIG. 10. Plan view pieces s#18 & 18a Axel Ends. Piece #18b Axel. Plan view piece #19 Drive Link. Piece #19a Drive Link Axel. Piece #20 Drive Link. Piece #21 Rope Holder with weld.

FIG. 11. Plan view of Assembly 4, consisting of pieces #18, #18a, #18b, #19, #19a, #20 & #21. Cross section of Assembly 4, consisting of pieces #18, #18a, #18b, #19 & #19a. Side view of pieces #20 & #21.

FIG. 12. Piece #5 Right Side Main Frame. Piece #6 Left Side Main Frame. Plan and side views of piece #9 Operating Link Bearing.

FIG. 13. Piece #8 Front Main Frame. Side and plan views of pieces #12 & #13 Handle Brackets. Piece #22 Cutter Return Spring.

FIG. 14. Plan view Assembly 5 consisting of pieces #5 & #6 welded to piece #4.

FIG. 15. Right and left side views of Assembly 5 consisting of pieces #4, #5, #6, #8, & #9.

FIG. 16. Top view of Assembly 5 showing pieces #4, #5, #6, #8, #9, #12 & #13. with exploded view of welds.

FIG. 17. Assemblies 1, 4 & 5 showing position of piece #22 Cutter Return Spring. Drawing not to scale.

FIG. 18. Assembly 6 Catch Basket right and left views showing complete assembly of basket with welds, side guides, and handle brackets in place.

FIG. 19. Assembly 6 Catch Basket, top view showing assembly and attachment to Stationary Handle.

FIG. 20. Assembly 6 Catch Basket, bottom view showing assembly and attachment to Stationary Handle.

FIG. 21. Side view of Assembly 7 Stationary Handle, showing pieces #23 Handle & #24 Handle Connector (Male).

FIG. 22. Plan view of Assembly #7 Stationary Handle showing attachment of Assembly 5 Main Frame.

FIG. 23. Right side view of Assembly 7 Stationary Handle showing attachment of Assembly 6 Catch Basket.

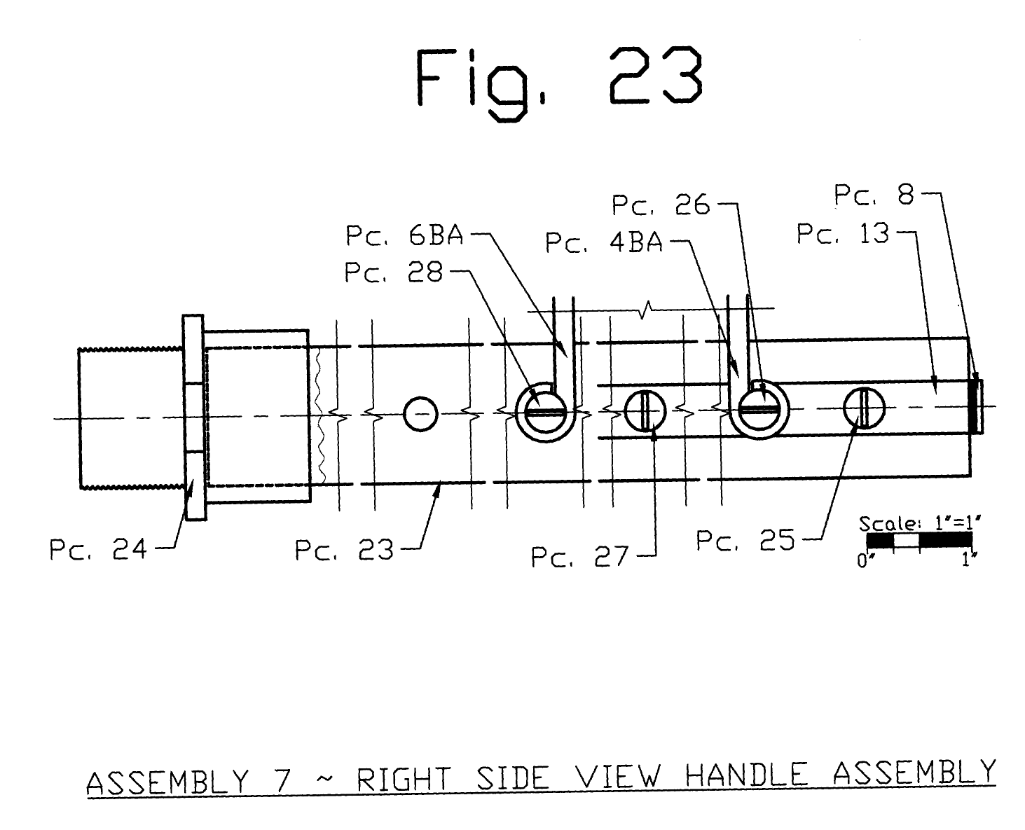

FIG. 24. Plan and side view piece #29 Operating Handle Rope Cleat. Plan view piece #30 Operating Handle. Side and end views pieces #32 Receiver for piece #10 & #32EX Extension Handle Receiver for piece #10.

FIG. 25. Plan and side views of Assembly #8 showing welding of piece #29 to piece #30; showing attachment to either Stationary handle or Extension Handle.

FIG. 26. Assembly #8 showing rope in operating position in pieces #28 & #29. Also showing attachment of Extension Handle to Stationary handle.

FIG. 27. Side View Assembly #4 to Main Frame.

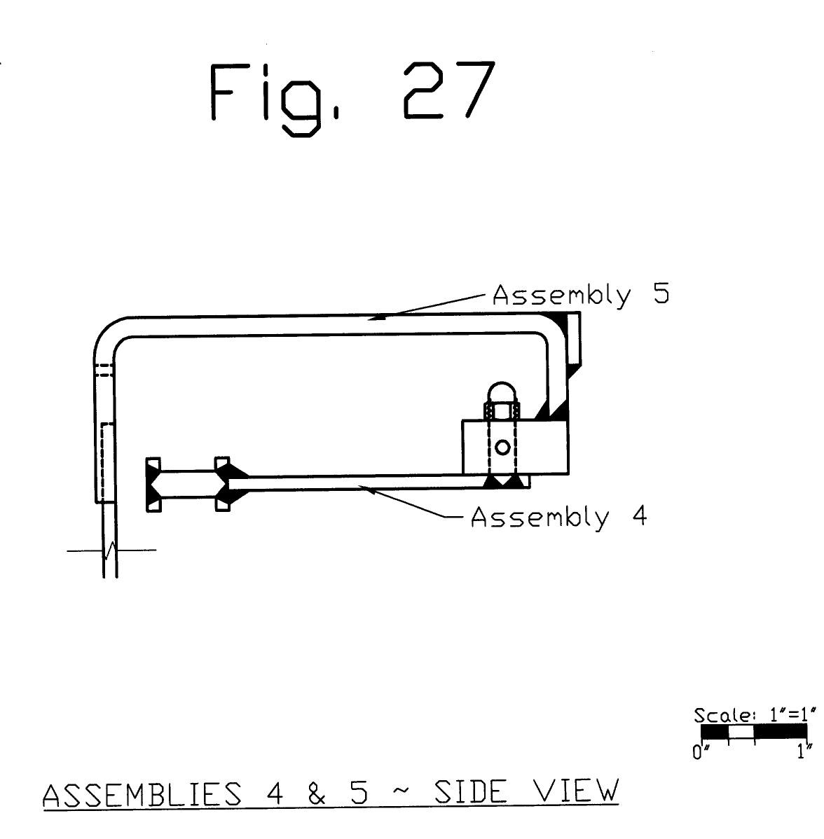

FIG. 28. Exploded view of sequence of assembling Assemblies #1 through #7.

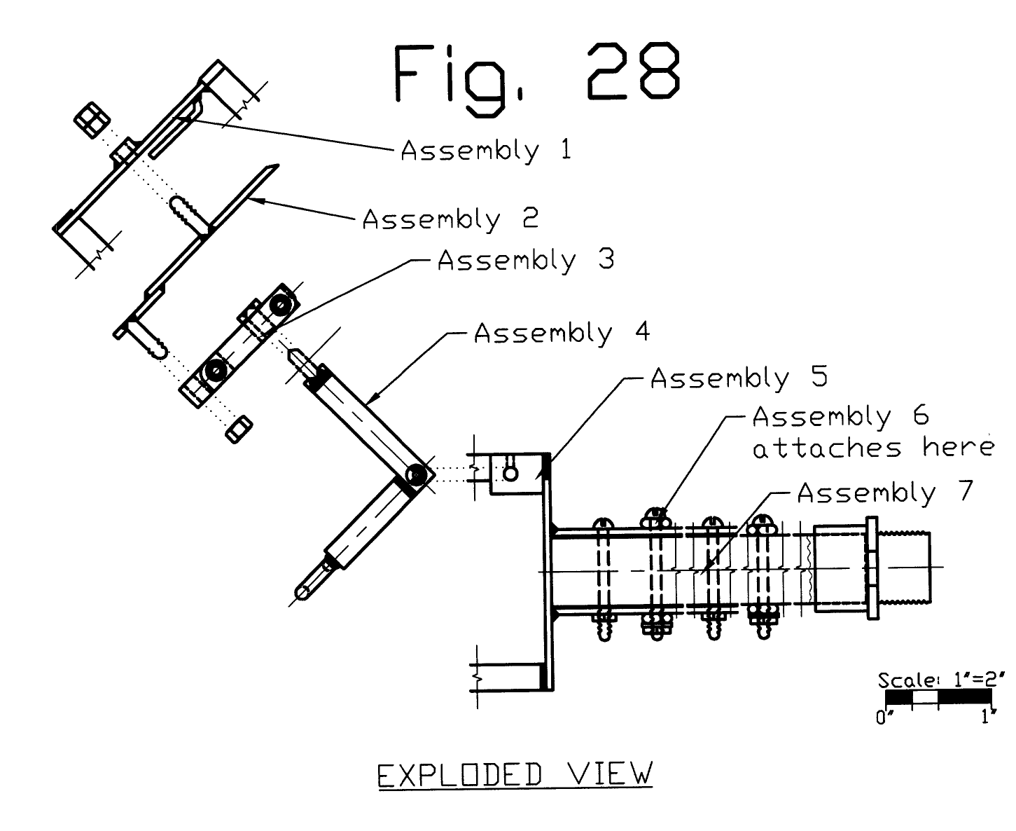

FIG. 29. Full Assembly Sketch of FRUIT PICK suitable for publication.

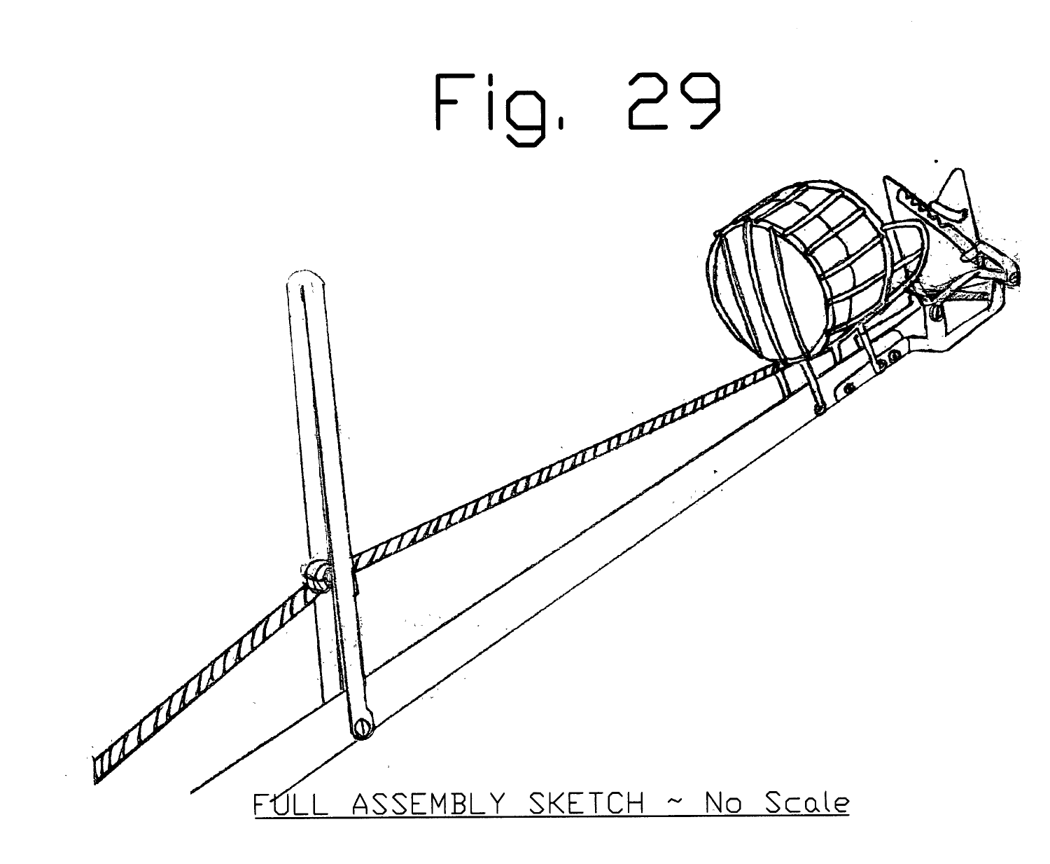

FIG. 30. Head Assembly close-up sketch.

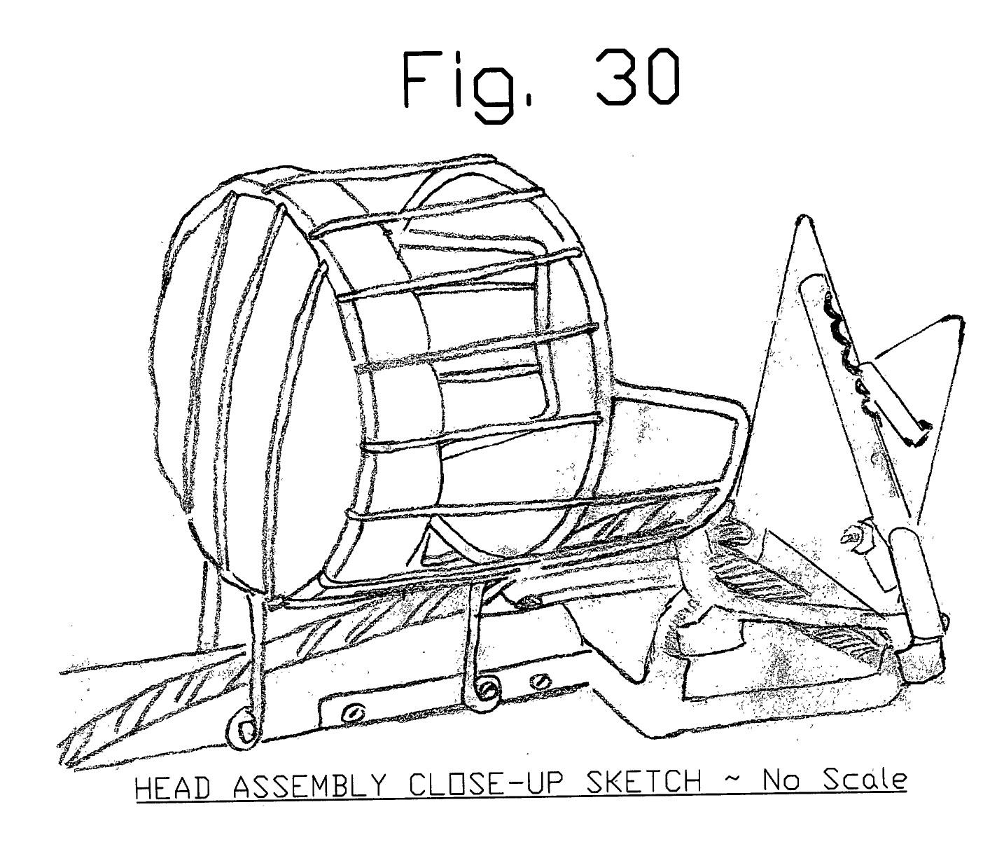

### DETAILED DESCRIPTION OF THE INVENTION

The FRUIT PICK has a six foot handle in two sections each three feet in length. The stationary cutting blade and the mobile cutting blade along with the operating linkage are the primary differences between this fruit picker and other fruit pickers currently on the market. The design on these blades is such that they cut the stems of the fruit instead of pulling the fruit from their stems as in other models. The operation of these blades is accomplished with a rope assembly instead of an operating rod and operating handle as in other models. I used a new catch basket design with side guides to ensure that the fruit is caught as soon as the stem is cut, so that it doesn't drop to the ground and get bruised.

### Material List

1—4⅞″ long×4″ wide×1/8″ thick carbon steel flat bar

1—62″ long×1/2″ wide×1/8″ thick mild steel flat bar

1—4¾″ long×3/4″ wide×1/8″ thick mild steel flat bar

1—12¾″ long×1/2″ wide×3/6″ thick mild steel flat bar

1—1″ long×3/4″ wide×1″ thick mild steel flat bar

1—2¼″ long×1⅝″ wide×1/8″ mild steel flat bar

1—72″ long×3/16″ round mild steel rod

1—7″ long×1/4″ round mild steel rod

1—¼″ long×1/2″ OD×1/4″ ID round mild steel

1—2″×½″×½″ mild steel square

1—⅜″ diameter×2″ long retracting spring wire 0.040 diameter±0.010-0.05

1—110″ #10 steel wire

1—6′ long×1″ schedule 40 PVC pipe

1—1″ schedule 40 PVC coupling with male thread

1—1″ schedule 40 PVC coupling with female thread

1—3″ long 1/8″ standard steel pipe.

1—10′×½41 diameter non-nylon rope

1—2½″33 ¼-20 hex head mild steel bolt

4—2½″×10-32 round head mild steel bolts

3—¼-20 standard nuts

4—3/16 flat washers

1—can PVC cement

1—6″ diameter×1/2″ thick piece of foam rubber

### Parts List

### Assembly #1

Pc. 1 Mobile Cutter Bearing

Pc. 2 Right Cutter Stop

Pc. 2a Left Cutter Stop

Pc. 3 Mobile Cutter Guide

Pc. 4 Main Cutter

### Assembly #2

Pc. 14 Mobile Cutter

Pc. 14a Mobile Cutter Offset

Pc. 14b Mobile Cutter Axel

Pc. 14c Universal Drive Axel

Pc. 14d ¼-20 Nut

Pc. 14e ¼-20 Nut

Pc. 14f ¼-20 Lock Nut

### Assembly #3

Pc. 15 Universal Connector

Pc. 15a Universal Axel

Pc. 15b Universal Axel

Pc. 15c ¼-20 Lock Nut

Pc. 15d ¼-20 Lock Nut

Pc. 16 Universal Bearing

Pc. 17 Universal Bearing

### Assembly #4

Pc. 18 Axel End

Pc. 18a Axel End

Pc. 18b Axel

Pc. 19 Drive Link

Pc. 19a Drive Link Axel

Pc. 19c ¼-20 Lock Nut

Pc. 20 Drive Link

Pc. 21 Rope Holder

### Assembly #5

Pc. 5 Right Side Main Frame

Pc. 6 Left Side Main Frame

Pc. 8 Front Main Frame

Pc. 9 Operating Link Bearing

Pc. 12 Handle Bracket

Pc. 13 Handle Bracket

Pc. 22 Cutter Return Spring

### Assembly #6

Pc. 1BA Basket Top Ring

Pc. 2BA Basket Bottom Ring

Pc. 3BA Basket Top Left Bracket

Pc. 4BA Basket Top Right Bracket

Pc. 5BA Basket Bottom Right Bracket

Pc. 6BA Basket Bottom Left Bracket

Pc. 7BA Basket Left Guide

Pc. 8BA Basket Right Guide

Pc. 9BA Basket Left Guide Wire

Pc. 10BA Basket Left Guide Wire

Pc. 11BA Basket Right Guide Wire

Pc. 12BA Basket Right Guide Wire

Pc. 13-25BA Basket Side Wires

Pc. 26BA Basket Left Bottom Wire

Pc. 27BA Basket Middle Bottom Wire

Pc. 28BA Basket Right Bottom Wire

### Assembly #7

Pc. 23 Handle

Pc. 23EX Extension Handle

Pc. 24 Handle Connector (Male)

Pc. 24EX Extension Handle Connector (Female)

Pc. 25 10-32 Handle Bracket Bolt

Pc. 25a 10-32 Lock Nut for Pc. 25

Pc. 26 10-32 Basket bolt

Pc. 26a 10-32 Lock Nut for Pc. 26

Pc. 26b 3/16″ Flat Washer for Pc. 26 & 26a

Pc. 27 10-32 Bolt

Pc. 27c 10-32 Lock Nut for Pc. 27

Pc. 28 10-32 Basket Bolt

Pc. 28a 10-32 Lock Nut for Pc. 28

Pc. 28b 3/16″ Flat Washer for Pc. 28 & Pc. 28a

### Assembly #8

Pc. 10 10-32 Rope Handle Bolt

Pc. 11 10-32 Lock Nut for Pc. 10

Pc. 23EX Handle Extension

Pc. 24EX Handle Extension Connector

Pc. 29 Operating Handle Rope Cleat

Pc. 30 Operating Handle

Pc. 32 Receiver for Pc. 10

Pc. 32EX Extension Handle Receiver for Pc. 10

Pc. 33 Rope

### Manufacturing Proceedures

### Assembly #1—Stationary Cutter

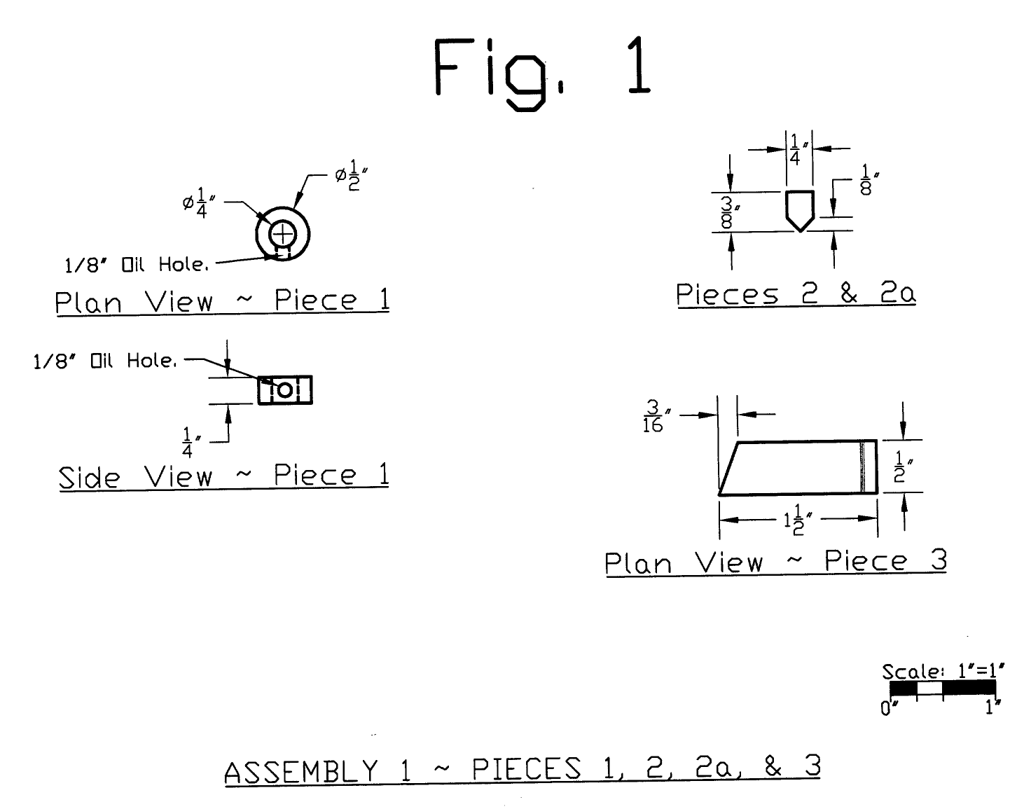

Piece #1—Mobile Cutter Bearing, FIG. 1

1. Cut from a piece of 1/8″ ID C-1 carbon steel pipe drilled out to 1/4″ ID as shown in FIG. 1.

Pieces #2 & #2a—Cutter Stops, FIG. 1

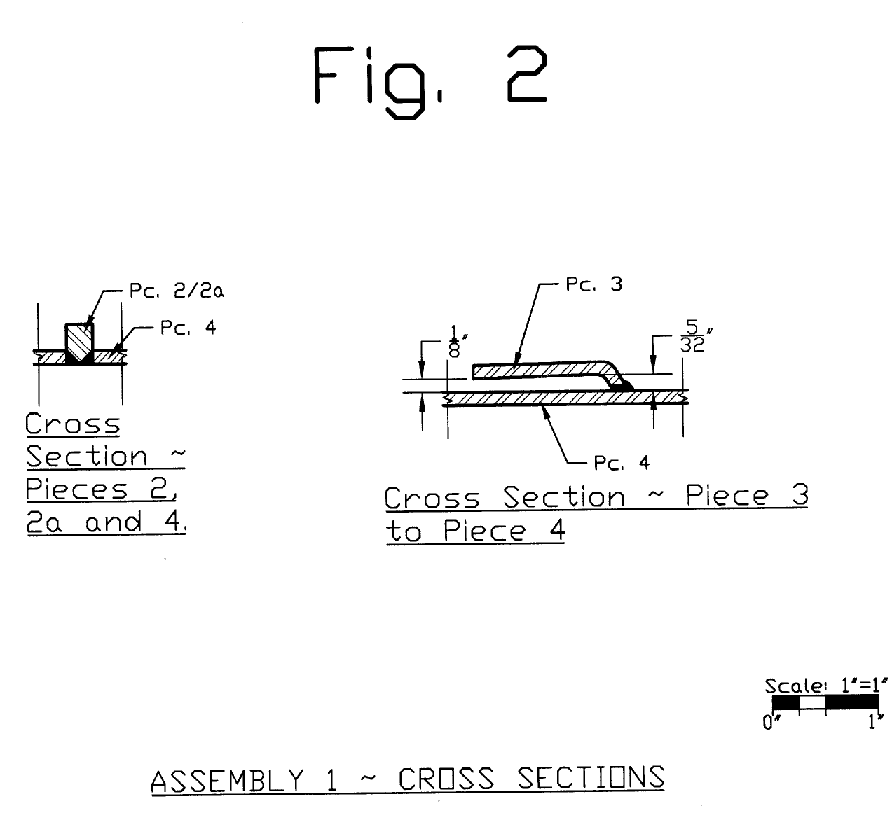

1. Cut from 1/4″ OD mild steel round bar and shape to dimensions in FIGS. 1 and 2

Piece #3—Mobile Cutter Guide, FIG. 1

1. Cut from 1/2″ wide by 1/8″ thick mild steel flat bar to dimensions in FIG. 1.

2. Bend as shown in FIG. 2.

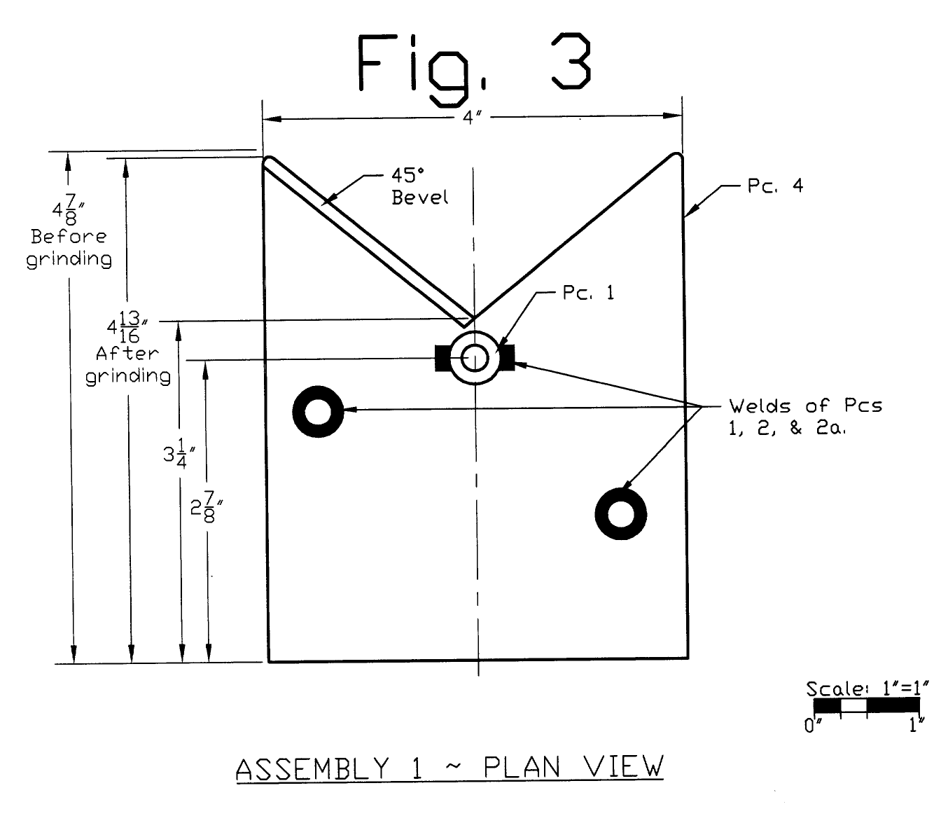

Piece #4—Stationary Cutter, FIGS. 3 & 4

1. Layout and cut from 1/8″ thick C-1 carbon steel flat bar or equivalent as shown in FIG. 3.

2. Drill and countersink 1/4″ diameter holes for pieces #1 , 2 & 2a as shown in FIGS. 2, 3 & 4.

3. Cut a 45° Bevel on top cutting edge to dimensions shown in FIG. 3.

### Assembling Stationary Cutter

1. Weld pieces #1, 2, 2a, and 3 to piece #4 as shown in FIGS. 2, 3 & 4.

### Assembly #2 Mobile Cutter

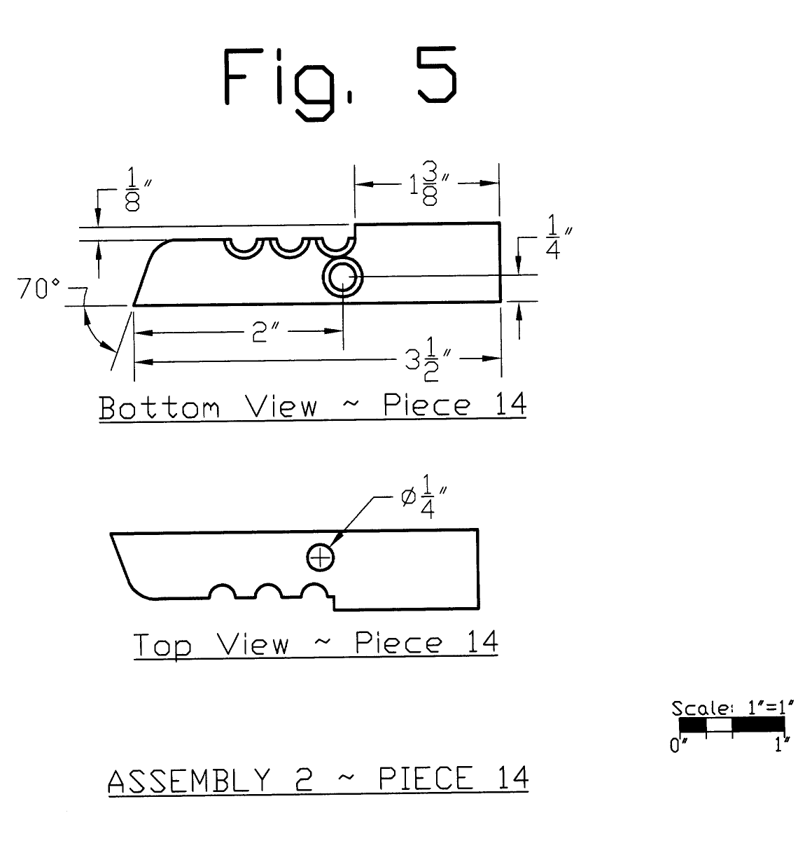

Piece #14—Mobile Blade, FIG. 5

1. Cut from a piece of 3/4″ wide×1/8″ thick C-1 carbon steel flat bar as shown in FIG. 5. Round top left edge as shown.

2. Cut and bevel saw tooth cutting edge 35° 5/32 inch deep as shown in bottom view on FIG. 5.

3. Drill and countersink a 1/4″ diameter hole as shown in bottom view FIG. 5.

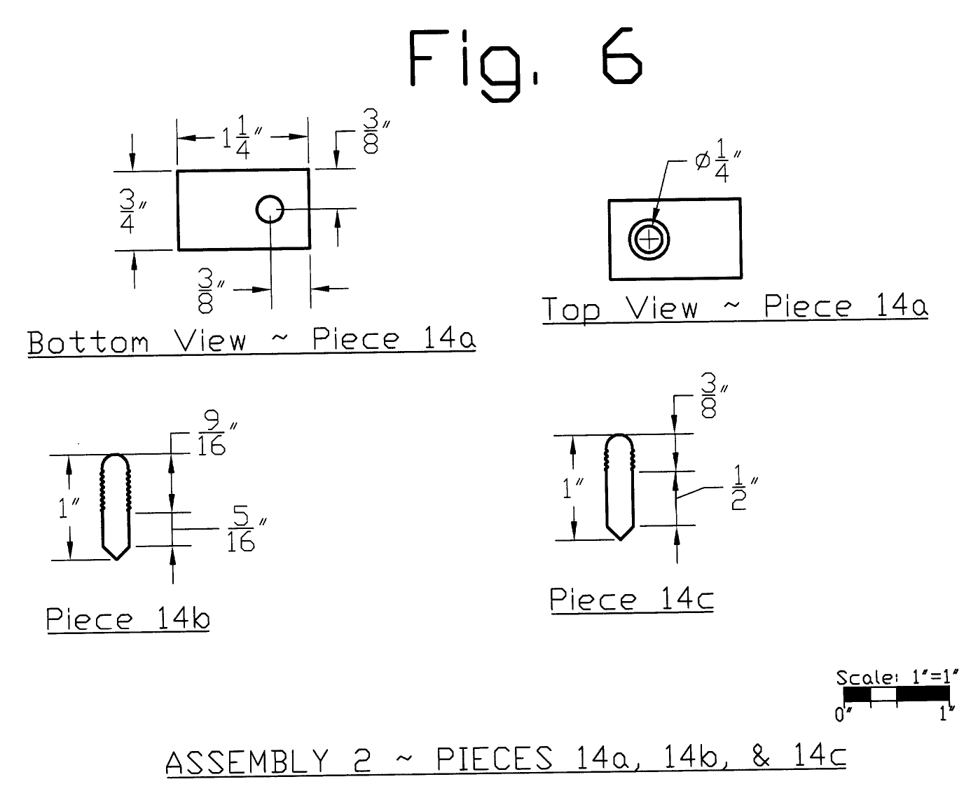

Piece #14a—Mobile Blade Extention, FIG. 6

1. Cut from a piece of 1/4″ wide×1/8″ thick C-1 carbon steel flat bar as shown in FIG. 6.

2. Drill and countersink a 1/4″ diameter hole as shown in top view FIG. 6.

Piece #14b—Mobile Cutter Axel, FIG. 6

1. Cut from a piece of 1/4″ mild steel round rod to dimensions in FIG. 6.

2. Cut (1/4-20) thread as shown in FIG. 6

Piece #14c—Mobile Cutter Universal Axel, FIG. 6

1. Cut from a piece of 1/4″ mild steel round rod to dimensions in FIG. 6.

2. Cut (1/4-20) thread as shown in FIG. 6.

Assembling Mobile Cutter

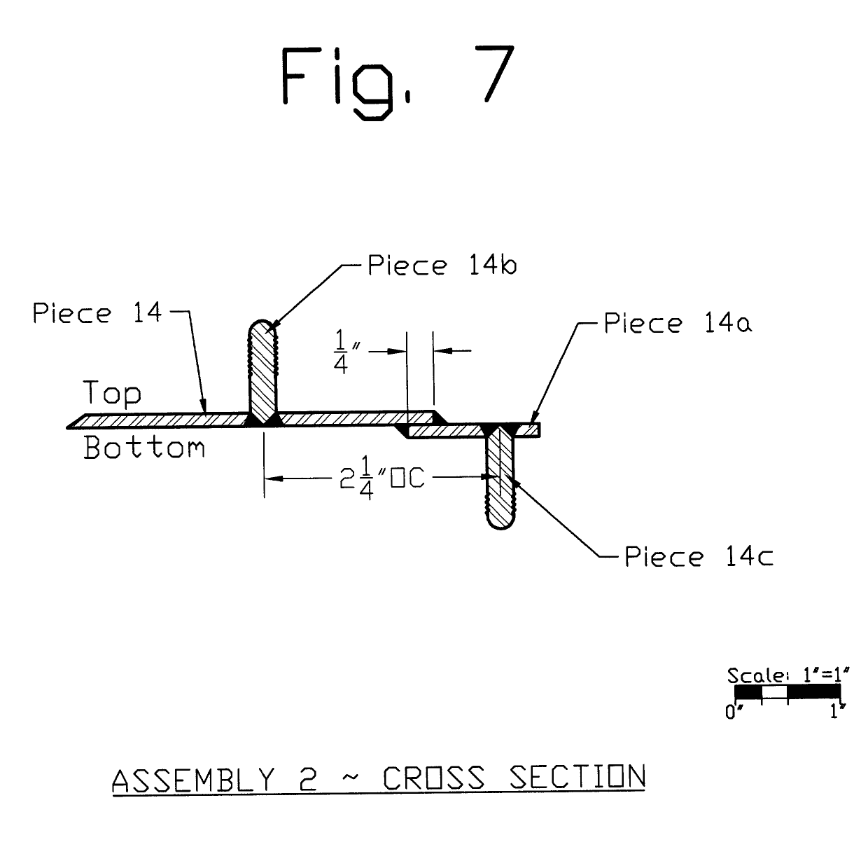

1. Weld pieces #14a, #14b, & #14c to piece #14 as shown in FIG. 7

### Assembly #3, Double Universal Assembly

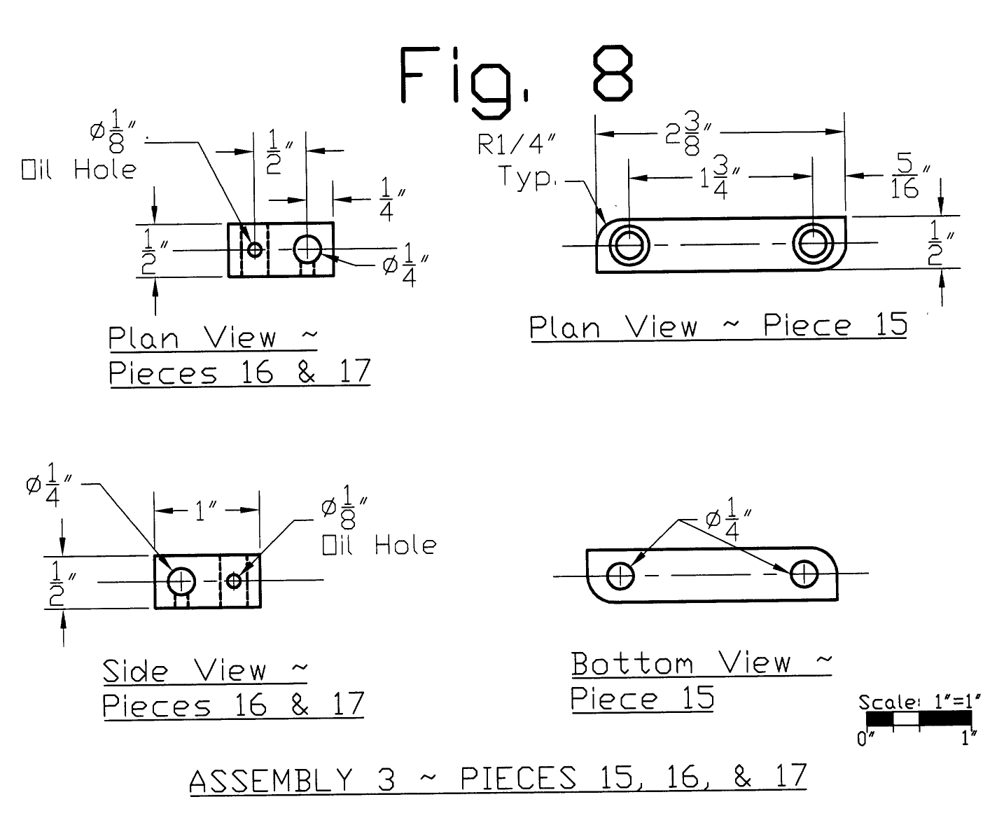

Piece #15—Universal Connector, FIG. 8

1. Cut from 1/2″ by 1/8″ thick mild steel flat bar as shown in plan view FIG. 8.

2. Drill 1/4″ diameter holes as shown in bottom view FIG. 6.

3. Countersink holes as shown in plan view FIG. 8.

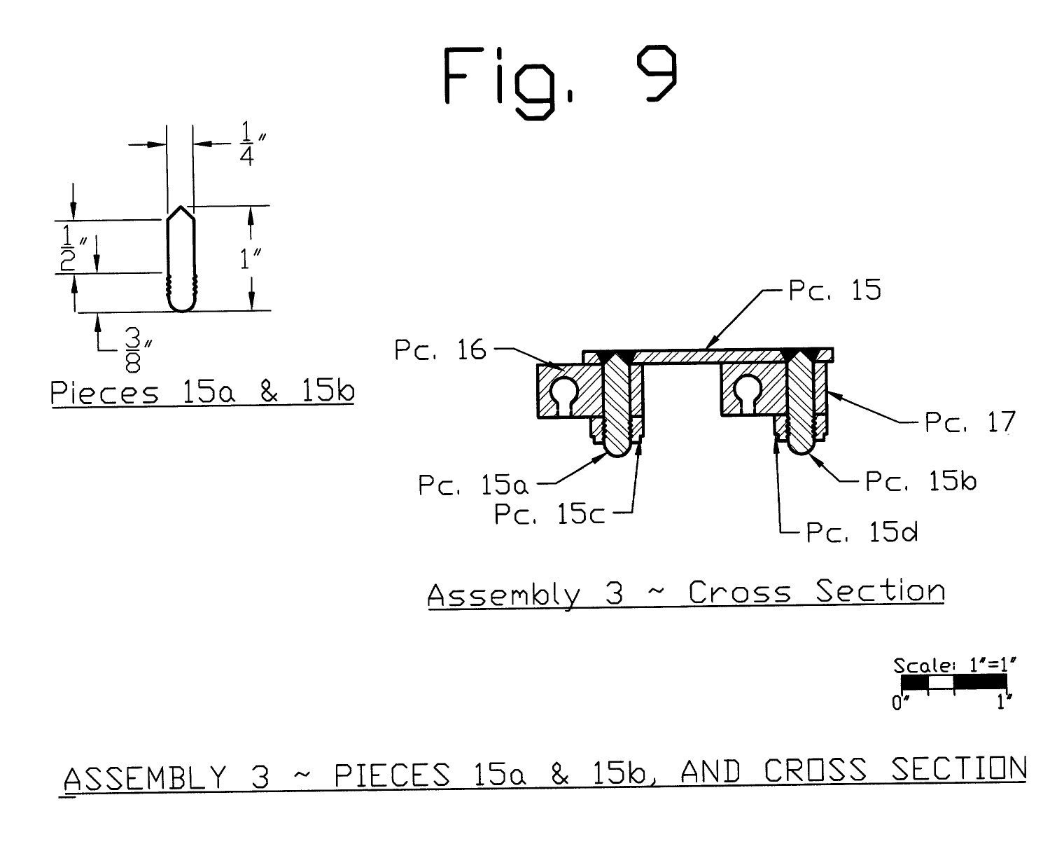

Pieces #15a & #15b—Universal Axels, FIG. 9

1. Cut from 1/4″ OD mild steel round bar to dimensions as shown in FIG. 9.

2. ¼-20 thread as in FIG. 9.

Pieces #16 & #17—Universal Joint Blocks, FIG. 8

1. Cut from 1/2″ square mild steel bar as per plan view FIG. 8.

2. Drill 1/4″ diameter holes as shown in plan and side views FIG. 8.

3. Drill 1/8″ diameter oil holes as shown in plan and side views FIG. 8.

### Assembling Double Universal Assembly

1. Insert pieces #15a & #15b through holes in piece #14 and weld as shown in FIG. 9.

2. Place pieces #16, & #17 on pieces #15a & #15b as shown in FIG. 9.

3. Secure pieces #16 & #17 with pieces #15c & #15d. Turn Pieces #15c & #15d finger tight then back off 1/8th turn.

### Assembly #4, Drive Link

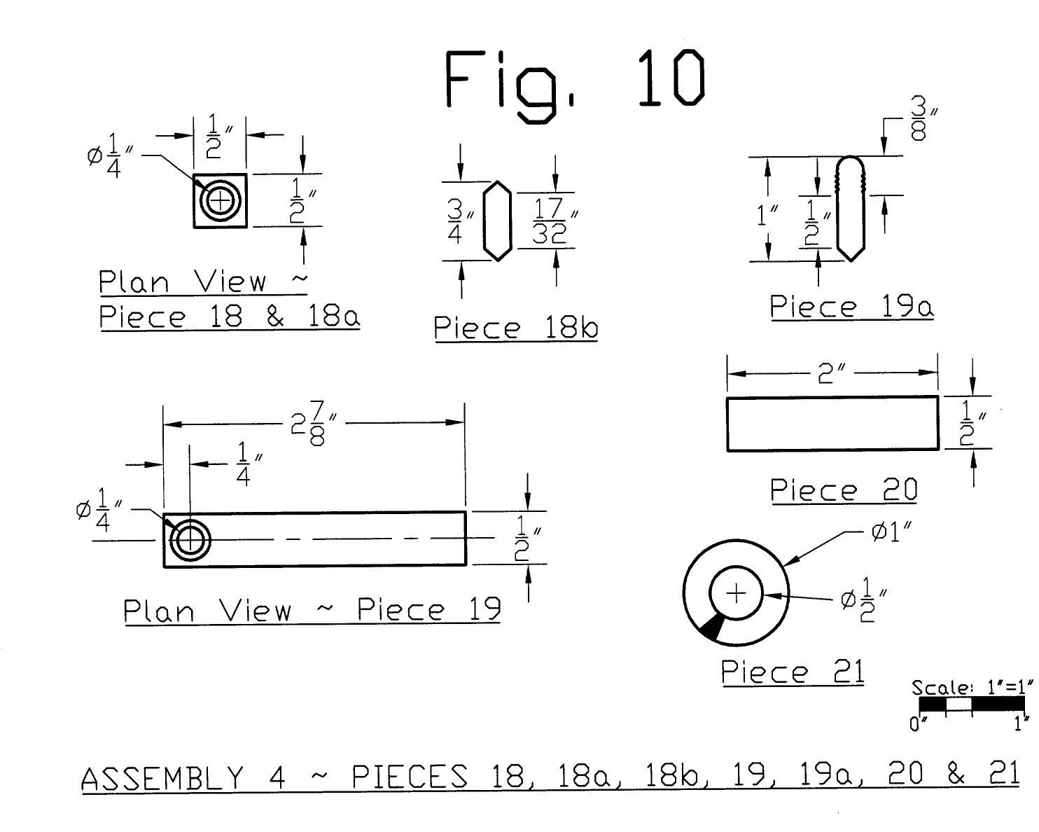

Pieces #18 & #18a, FIG. 10

1. Cut from 1/2″ wide×1/8″ thick mild steel flat bar as shown in FIG. 9.

2. Drill and countersink a 1/4″ diameter hole as shown in FIG. 9.

Piece #18b, FIG. 10

1. Cut from 1/4″ OD mild steel round bar to dimensions shown in FIG. 9.

2. Bevel ends for welding as shown in FIG. 10.

Piece #19, FIG. 10

1. Cut from 1/2″ wide×1/8″ thick mild steel flat bar to dimensions as shown in FIG. 10.

2. Drill and countersink a 1/4″ diameter hole from top as shown in FIG. 10.

Piece #19a—Drive Link Axel, FIG. 10

1. Cut from 1/4″ OD mild steel round bar to dimensions as shown in FIG. 10.

2. Cut 1/4-20 thread as shown in FIG. 10.

3. Bevel end for welding as shown in FIG. 10.

Piece #20, FIG. 10

1. Cut from 1/2″ wide by 1/8″ thick mild steel flat bar as shown in FIG. 10.

Piece #21, FIG. 10

1. Cut a 3⅛″ long piece from 1/4″ mild steel round bar.

2. Shape and weld as shown in FIG. 10.

### Assembling Drive Link

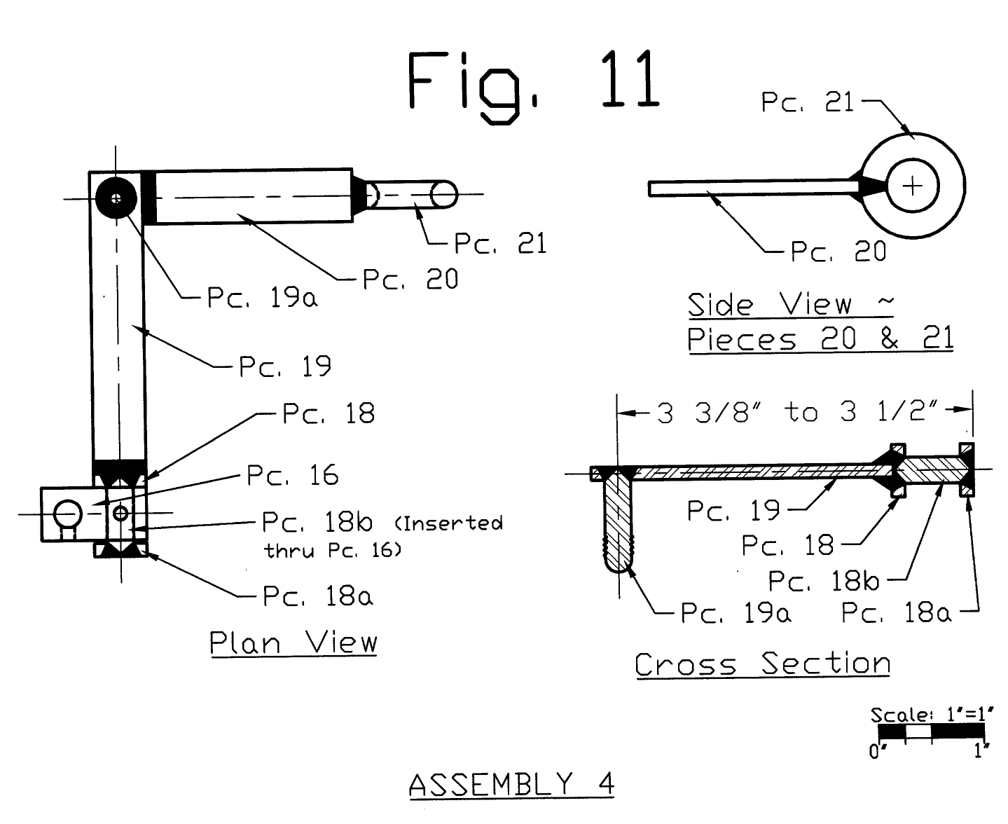

1. Align pieces #18 & #18b and weld as shown in cross section, FIG. 11 then weld to piece #19 as shown in FIG. 11.

2. Put piece #19a through hole in top of piece #19 and weld in place.

3. Align piece #20 with piece #19 and weld as shown in FIG. 11

4. Align piece #21 with piece #20 and weld as shown in both plan view and side view in FIG. 11.

### Assembly #5, Main Frame Assembly

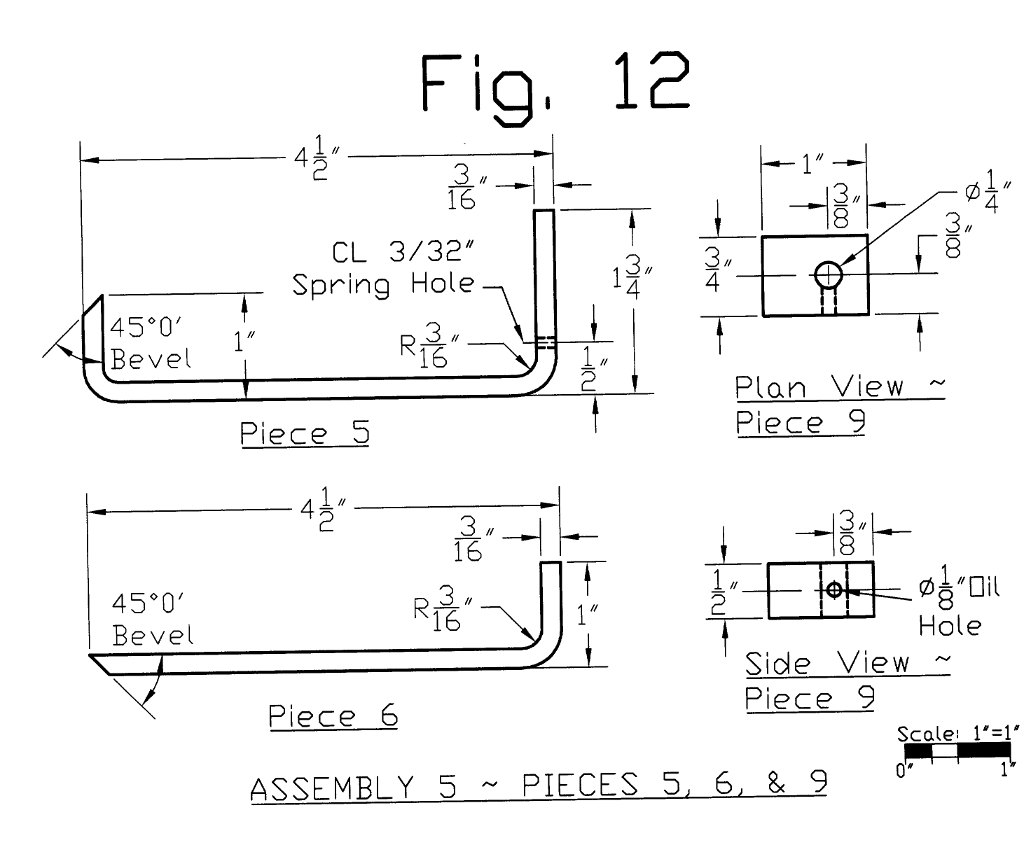

Piece #5, FIG. 12

1. Cut a piece of 1/2″ wide×3/16″ thick mild steel flat bar and shape as shown in FIG. 12.

2. Cut a 45° bevel on left end.

3. Drill a 3/32″ diameter hole 1/2″ from bottom and 1/8″ from inside edge of piece #5 for spring as shown in FIG. 12.

Piece #6, FIG. 12

1. Cut a piece of 1/2″ wide×3/16″ thick of mild steel flat bar and shape as shown in FIG. 12.

2. Cut a 45° bevel on left end.

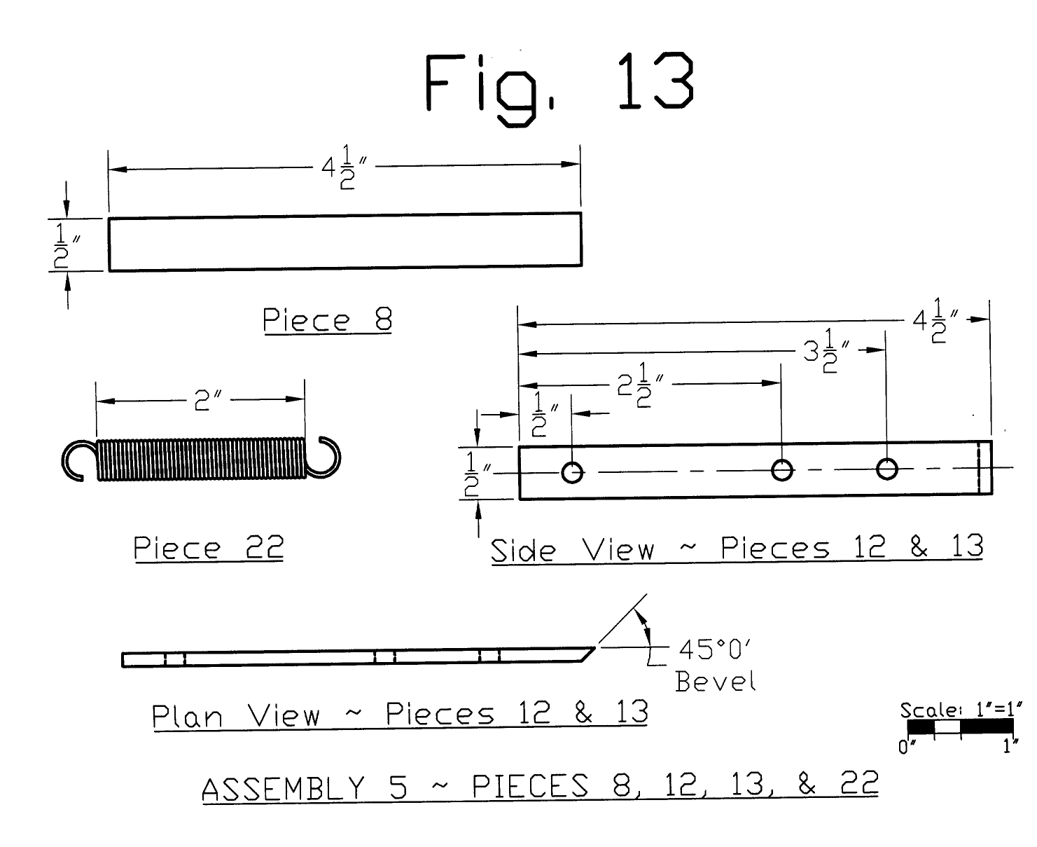

Piece #8, FIG. 13

1. Cut a piece of 1/2″ wide by 1/8″ thick mild steel flat bar as shown in FIG. 13.

1. Cut a piece of 3/4″ wide×1/2″ thick mild steel flat bar as shown in FIG. 12.

2. Drill a 1/4″ diameter hole 3/8″ from edge as shown in plan view on FIG. 12.

3. Drill a 1/8″ diameter oil hole 3/8″ from edge as shown in side view on FIG. 12.

Piece #22, FIG. 13

1. Piece #22 is a 3/8″ D.×2″ long spring—relaxed (Cutter Return Spring).

2. Piece #22 wire D. is 0.040±0.01-0.005″.

Pieces #12 & #13, FIG. 13

1. Cut a piece of 1/2″ wide×1/8″ thick mild steel flat bar as shown in FIG. 13.

2. Drill 3/16″ diameter holes as shown in FIGS. 13 & 14.

3. Cut a 45° bevel on right end as shown in FIG. 13.

### Assembling Main Frame

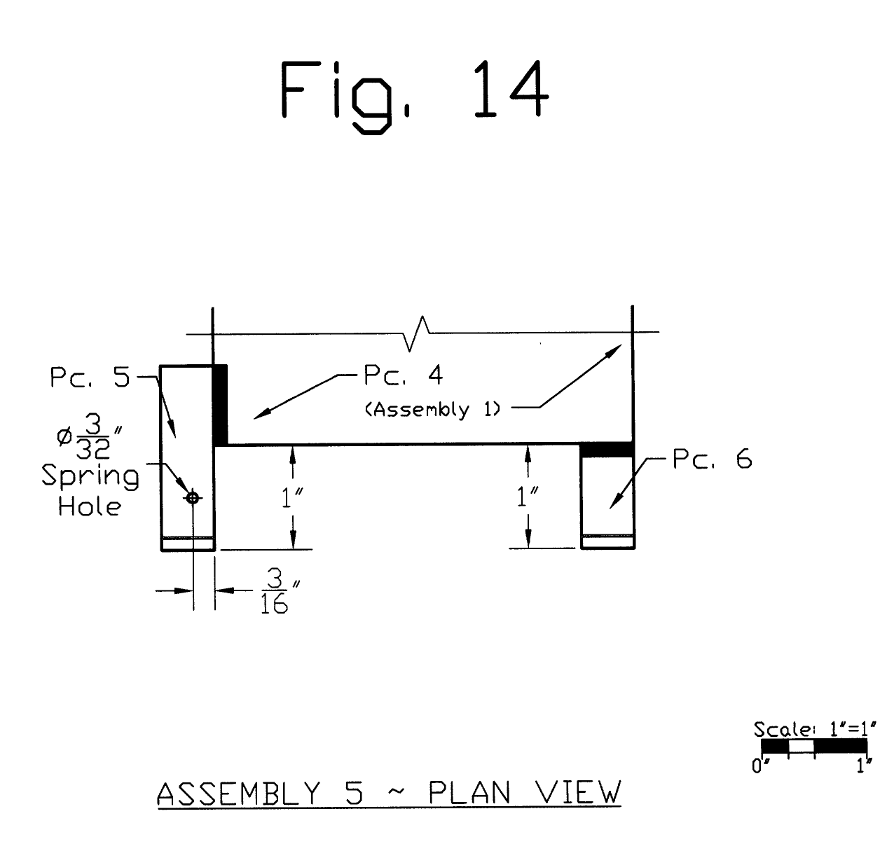

1. Align pieces #5 & #6 with piece #4 and weld as shown in FIGS. 14 & 16.

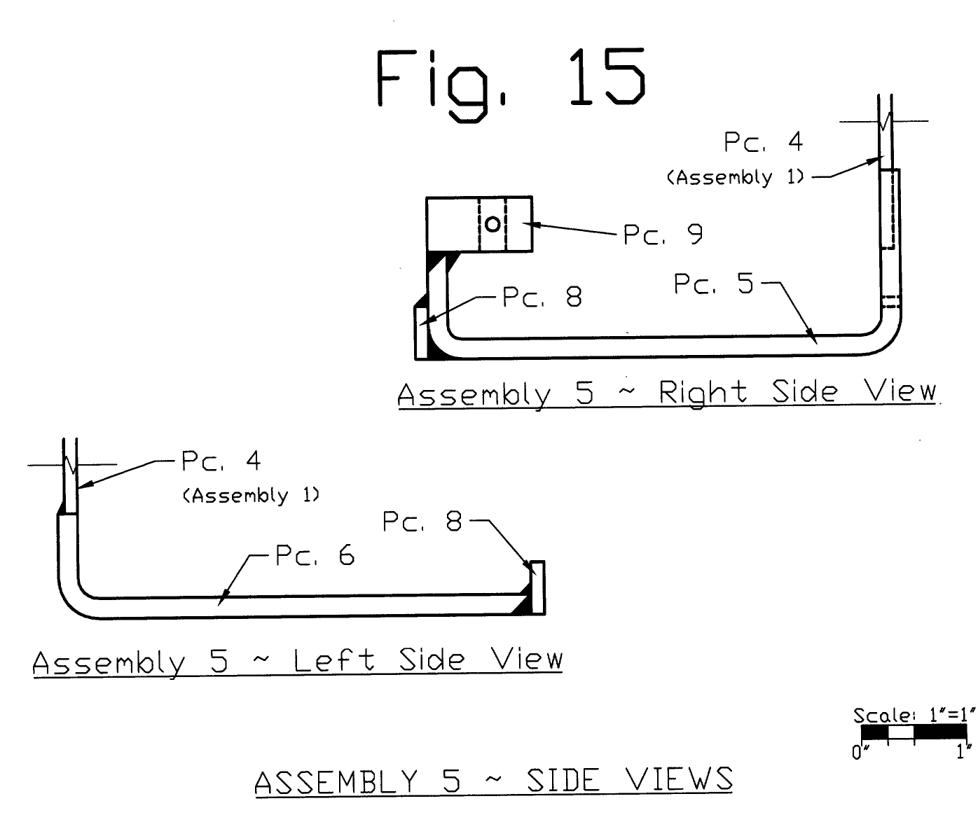

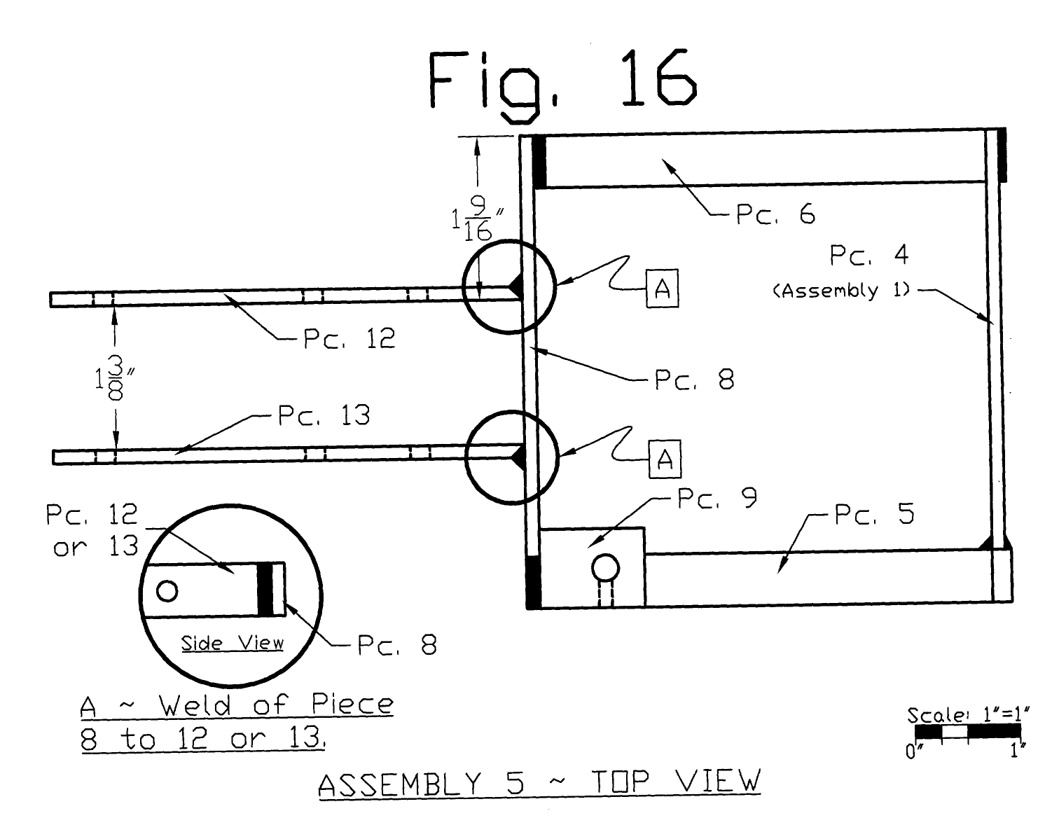

2. Align piece #8 with pieces #5 and #6 and weld as shown in left side view of FIG. 15 and plan view of FIG. 16.

3. Align piece #9 with piece #5 and weld as shown in right side view of FIG. 15 and TOP?? view of FIG. 16.

4. Align pieces #12 & #13 with piece #8 and weld in place (outside only) as shown on FIG. 16.

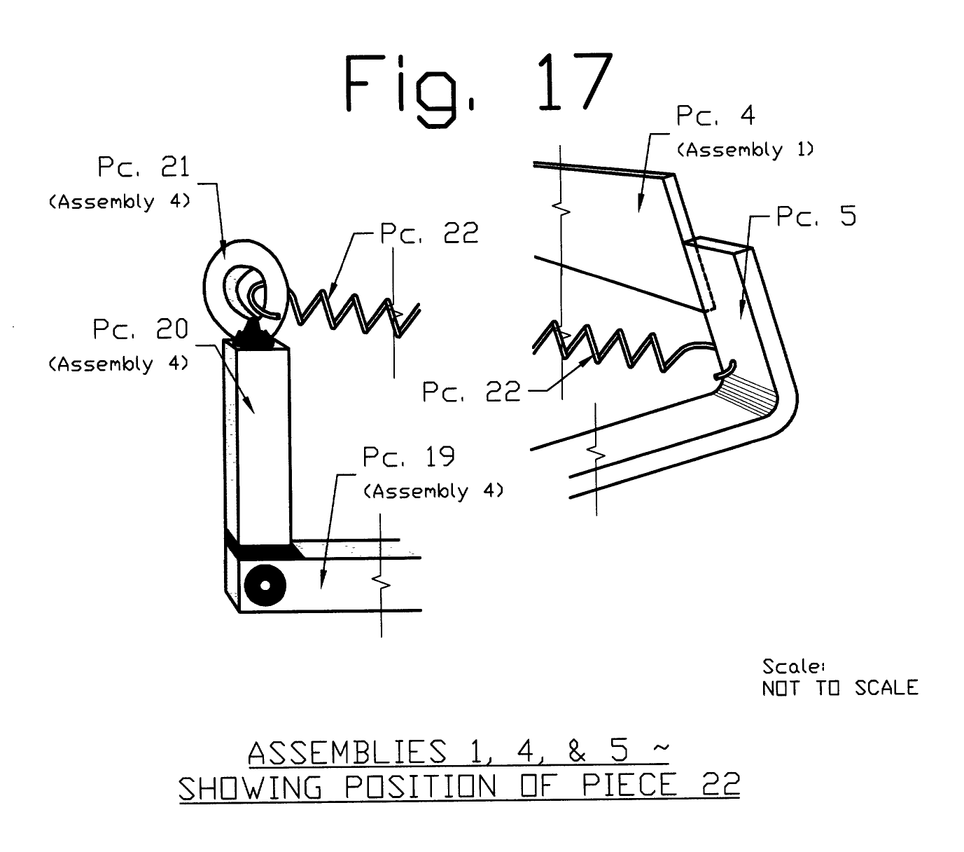

5. Insert and hook one end of piece #22 into piece #21 as shown in FIG. 17.

6. Insert other end of piece #22 into the spring hole in piece #5 as show in FIG. 17.

### Assembly #6, Basket

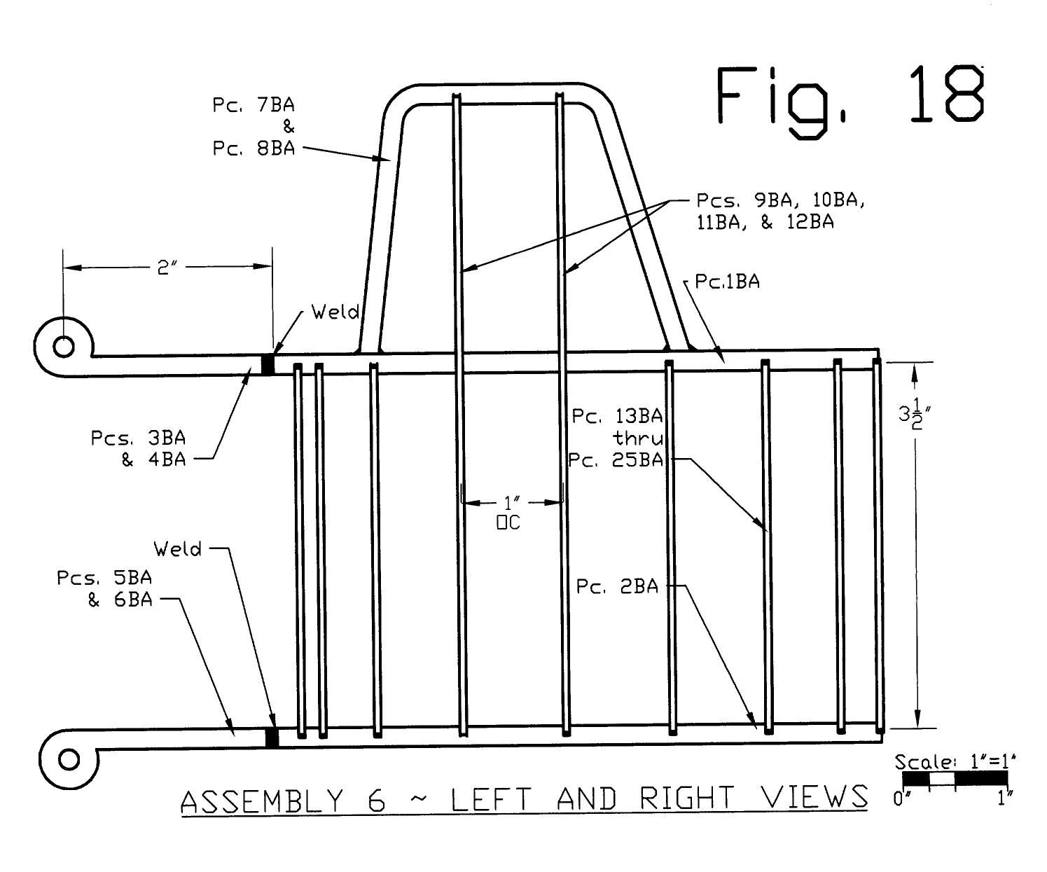

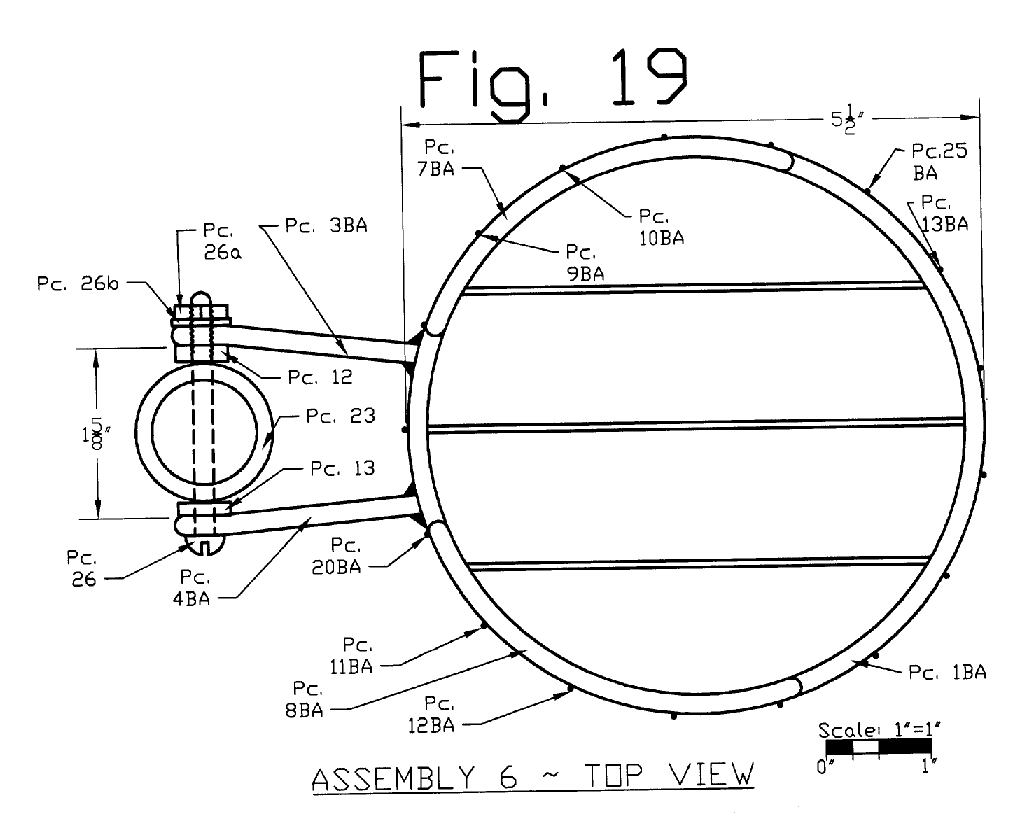

Pieces #1BA & #2BA Top and Bottom Ring FIGS. 18, 19 & 20

1. Cut pieces #1BA and #2Ba from 3/16″ round steel rod and roll out to two 5½″ OD rings.

2. Weld ends together forming two separate rings.

Pieces #3BA, #4BA, #5BA, & #6BA Basket Brackets FIG. 18

1. Pieces #3BA-#6BA are identical.

2. Cut pieces #3BA-6BA from 3/16″ round steel rod and shape as shown in FIG. 18.

3. Bevel ends as shown in FIG. 18 for welding to pieces #1 BA & #2BA.

Pieces #7BA & #8BA Side Guides, FIGS. 18 & 19

1. Piece #7BA is the left side guide, piece #8BA is the right side guide.

2. Cut a piece of 3/16″ round steel rod 7½″ long for piece #7BA and one for piece #8BA.

3. Make a 96° 30′ angle, 2 9/16″ from one end and a 107° angle 2 11/16″ from the other end of the rod as shown in FIG. 19 for piece #7BA.

4. Repeat for piece #8BA.

Pieces #9BA,#10BA,#11BA, & #12BA, FIG. 18

1. Cut four pieces of #10 steel wire 6″ long.

Pieces #13BA-#25BA, FIGS. 18 & 19

1. Cut 13 pieces of #10 steel wire 3½″ long.

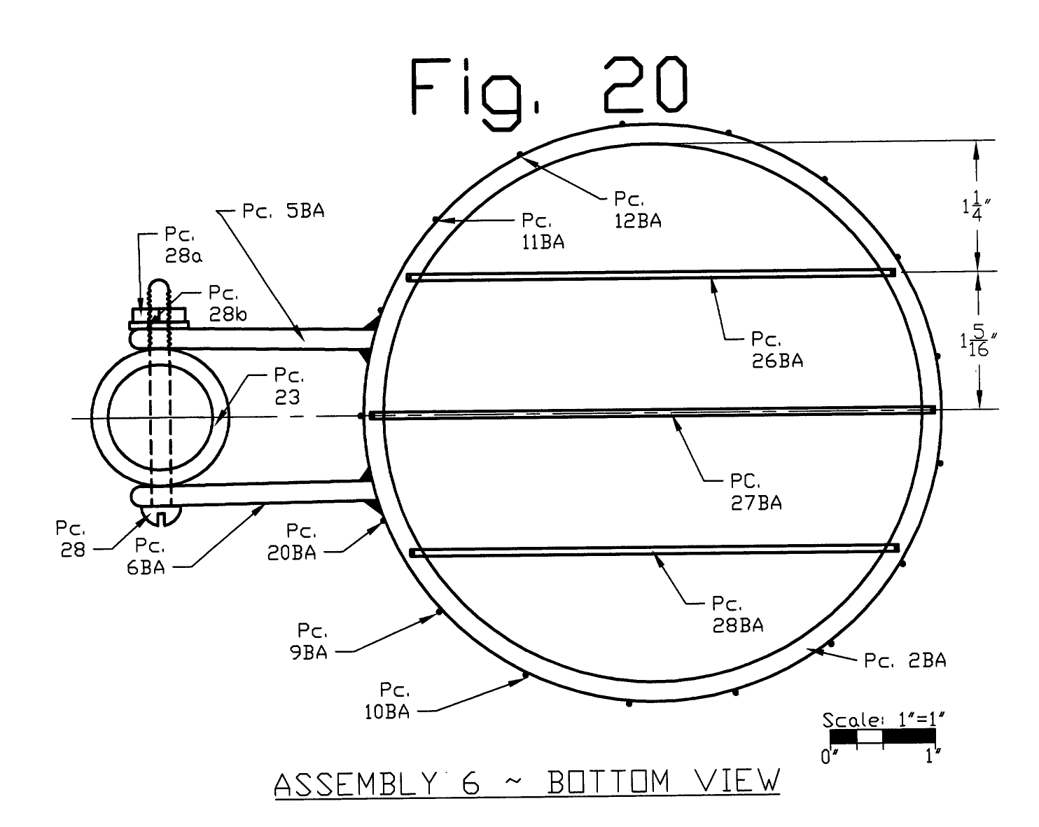

Pieces #26BA & #28BA, FIG. 20

1. Cut 2 pieces of #10 steel wire 4⅝″ long.

Pieces #27BA, FIG. 20

1. Cut a piece of #10 steel wire 5 5/16″ long.

### Assembling Basket

1. Weld pieces #3BA and #4BA to piece #1BA as shown in FIG. 19.

2. Weld pieces #5BA and #6BA to piece #2BA as shown in FIG. 20.

3. Weld pieces #13BA-#25BA to pieces #1BA and #2BA as shown in FIGS. 18, 19 & 20.

4. Weld ends of pieces #7BA and #8BA to piece #1BA as shown in FIG. 18.

5. Weld pieces #9BA and #10BA to pieces #7BA and #2BA as shown in FIG. 18.

6. Weld pieces #11BA and #12BA to pieces #8BA and #2BA as shown in FIG. 18.

7. pieces #26BA-#28BA on piece 2BA as shown in FIG. 20 and weld in place.

### Assembly #7, Handle Arrangement

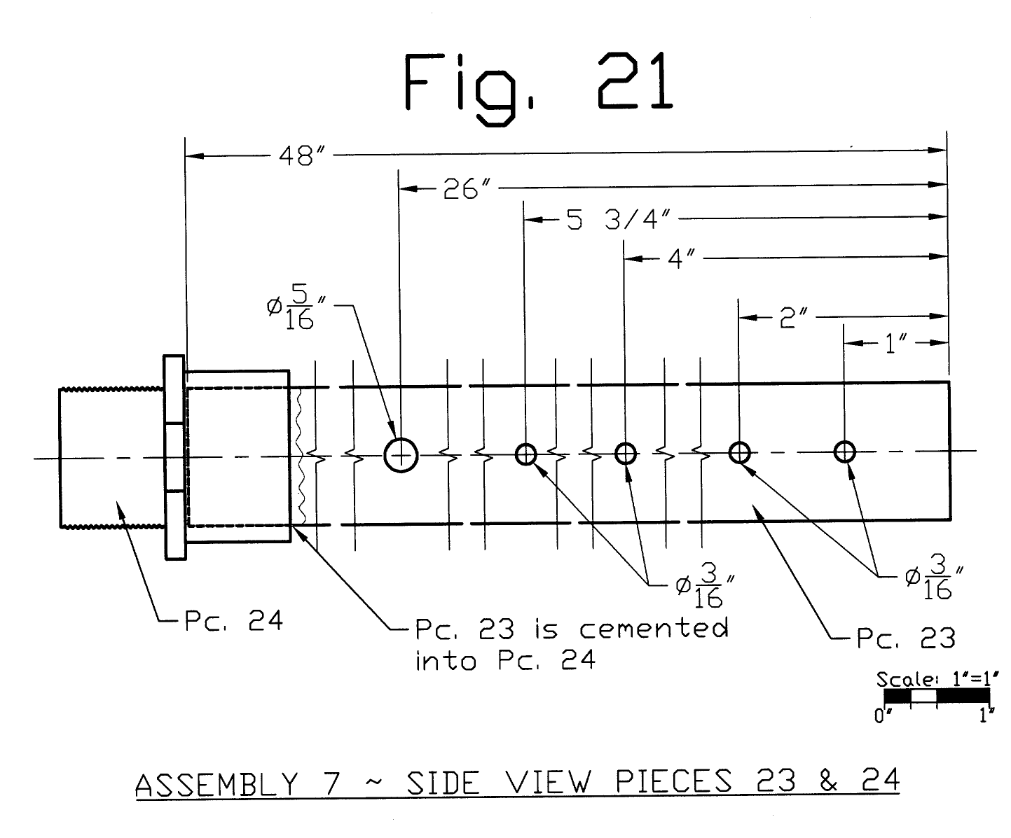

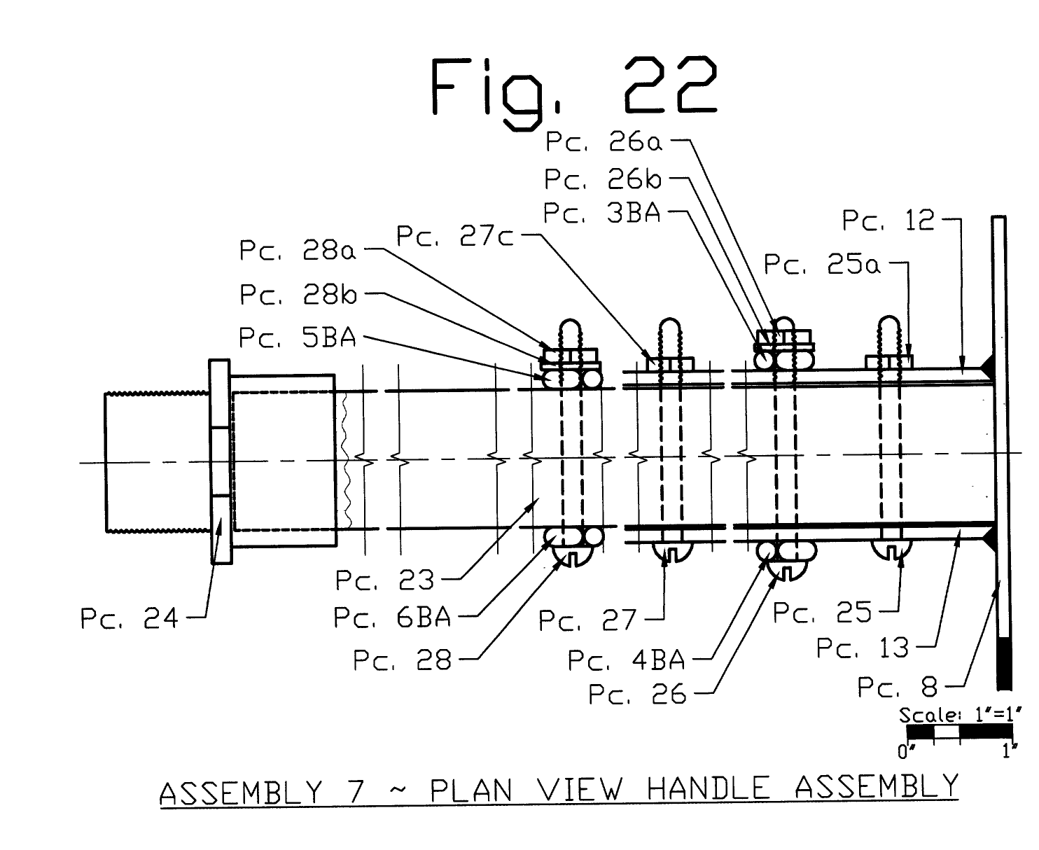

Pieces #23 (Primary Handle) and #23EX (Extension Handle), FIGS. 21, 22 & 23

1. Cut a 48″ long piece of 1″ schedule 40 PVC pipe for piece #23.

2. Drill 3/16″ diameter holes in piece #23 as shown in FIG. 21.

3. Drill 5/16″ hole 26″ from top of piece #23 as shown in FIG. 21.

4. Cut a 36″ long piece of 1″ schedule 40 PVC pipe for piece #23EX.

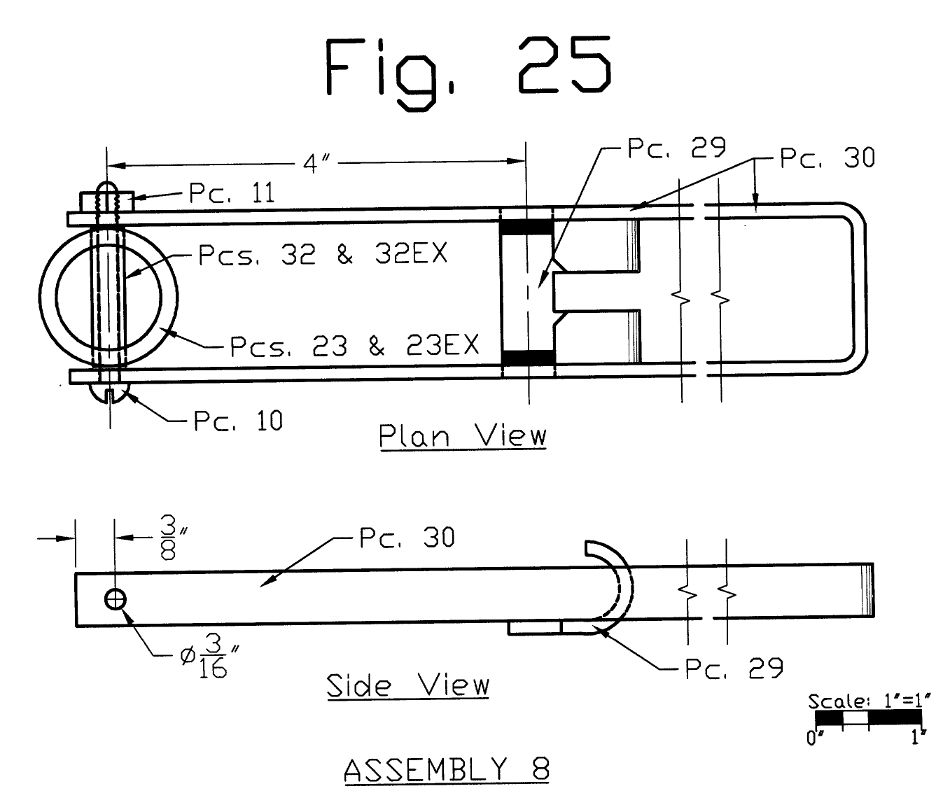

5. Drill 5/16″ hole 12″ from top of piece #23EX as shown in FIG. 25.

### Assembly #8, Operating Handle

Piece #29 Rope Holder, FIG. #24

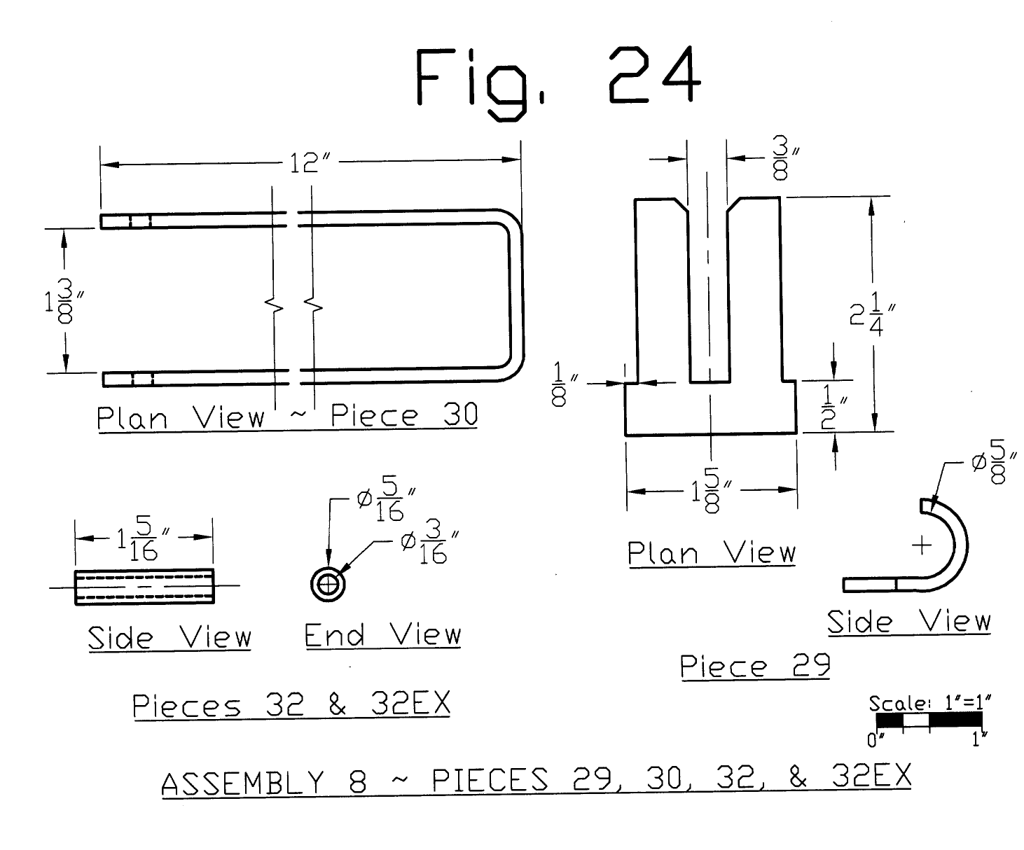

1. Cut a piece of 1⅝″ wide×2¼″ long×1/8″ thick mild steel flat bar and shape as shown in FIG. 24.

2. Bend as shown in side view FIG. 24.

Piece #30 Rope Puller, FIG. 24

1. Cut a piece of 1/2″ wide×25⅜″ long×1/8″ thick mild steel flat bar and shape as shown in FIG. 24.

2. Drill 3/16″ diameter holes 3/8″ from straight ends as shown in FIGS. 24 & 25.

Pieces #32 & #32EX—Bolt Sleeves, FIG. 24

1. Pieces #32 & 32EX are 1 5/16″ long pieces of 1/8″ standard steel pipe drilled out to 1/4″ ID as shown in FIG. 24. (“EX” pieces are for extension handle)

### Assembling Operating Handle

1. Weld piece #29 to piece #30 as shown in plan view of FIG. 25.

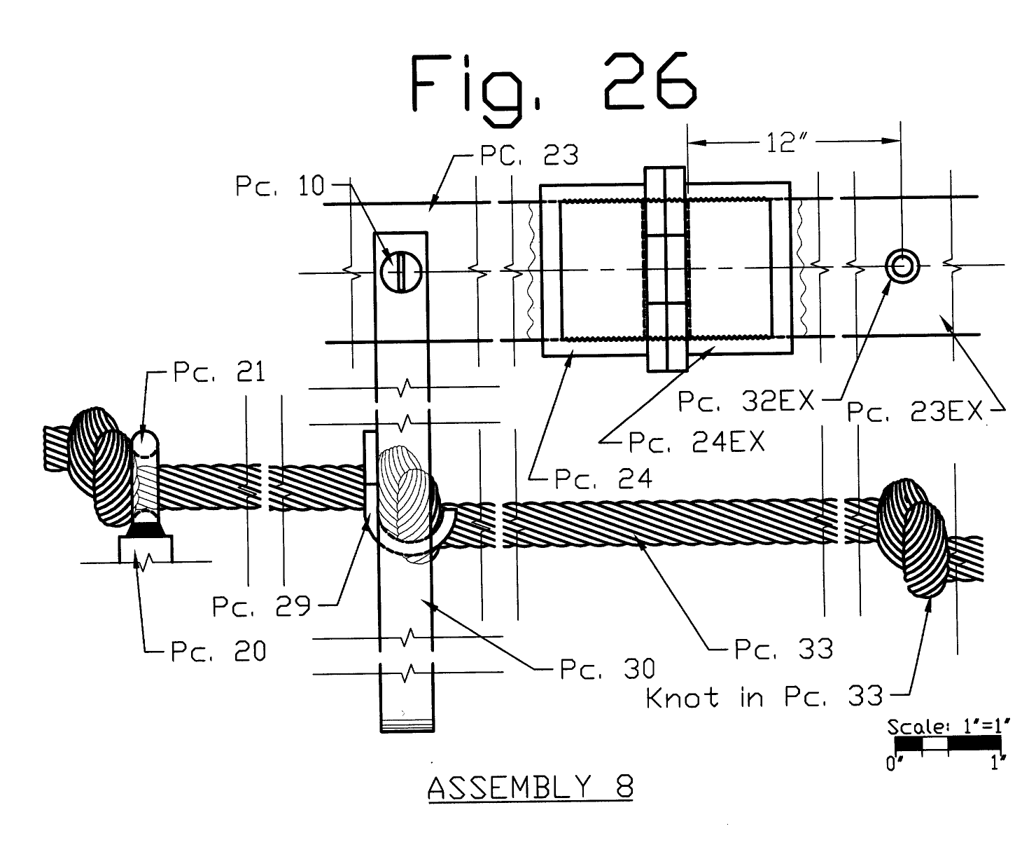

2. Attach rope as shown in FIG. 26. Knots placed to suit operation.

### Combining Assemblies

Coating

1. Paint, plate or plastic coat all pieces except bolts, nuts, washers and bearings.

Assemblies #1-#5

1. Insert piece #14b (assembly #2) through pieces #4 & #1 (assembly #1) see FIG. 26.

2. Put pieces #14 & 14e (adjustment nuts) on piece #14b and hand tighten then back off 1/8 turn, see FIG. 26.

3. Put piece #14c (assembly #2) through hole in piece #17 (assembly #3)

4. Put piece #14f on piece #14c (adjustment nut) and hand tighten then back off 1/8 turn.

5. Put piece #18b (assembly #4) through hole in piece #16 (assembly #3).

5. Align piece #18a (assembly #4) over piece #18b and place a 0.010-0 spacer between pieces #18a & #18b as shown in FIGS. 11 & 26.

6. Weld piece #18a to piece #18b as shown in FIG. 11.

7. Remove the spacer.

8. Align piece 19a (assembly #4) through piece #9 (assembly #5).

9. Put piece #19b (adjustment nut) on piece #9 as shown in side view of FIG. 24 and hand tighten then back off 1/8 turn.

### Assembling Handle Arrangement

1. Cement piece #24 on end of piece #23 as shown in FIG. 21.

2. Cement piece #24EX on end of piece #23EX as shown in FIG. 25.

3. Align assembly #5 (pieces #12 & #13) on piece #23 as shown in FIG. 24.

4. Insert pieces #25 & 27 through holes in pieces #12, #13, & #23 and tighten pieces #25a & #27c in place as shown in FIG. 22.

5. Align assembly #6 (pieces #3BA, #4BA, #5BA & #6BA) with holes in assembly #5 (pieces #12 & #13) and piece #23 as shown in FIGS. 22, 18, & 19.

6. Insert piece #26 through holes in pieces #3BA, #4BA, #12, #13, & #23 as shown in FIGS. 22 & 18.

7. Place piece #26b on piece #26, place and tighten piece #26a as shown in FIGS. 22 & 18.

8. Insert piece #28 through holes in pieces #3BA, #4BA, & #23 as shown in FIGS. 22 & 19.

9. Place piece #28b on piece #28, place and tighten piece #28a as shown in FIGS. 22 & 19.

10. Align piece #30 (assembly #8) with holes in piece #23 (assembly #7) insert piece #32.

11. Insert piece #10 through piece #32.

12. Put piece #11 on piece #10 (adjustment nut) and hand tighten and back off 1/8 turn.

13. Insert 3/8″ diameter rope through piece #21 and tie a knot in the end.

14. Holding piece #30 at a right angle to piece #23 tie a knot to fit into piece #29.

15. Insert piece #32EX into hole in piece 23EX

a. When extension handle is in place assembly #8—operating handle—is mounted here instead of at location stated in steps #10-#12 above.

b. When assembly #8 is moved to extension handle tie a new knot as stated in step #14 above.

### General Notes

1. All bearings have 45° tapered ends for welding

2. Double circle \mathring{◯} is a countersink for welding of piece in hole. Weld one side only other pieces both sides.

3. Bring bearing lock nuts within 1/8″ turn from firm leaving bearing loose.

4. Grease bearings and friction areas before assembly.

5. All metals are steel except as noted.

6. Shaded areas denote welds.

7. All welding done according to standard welding procedures.

8. All wire used to make basket is plastic coated.

1. I claim that the design of the stationary and mobile cutting blades are my invention. I claim that the linkage assembly attaching the blades to the operating handle are my invention. I claim that the basket side guides are my invention.
